(19) United States
(12) Patent Application Publication
(10) Pub. No.: US 2007/0050457 A1
(43) Pub. Date: Mar. 1, 2007

(54) Electronic mail device

(76) Inventors: Nobumi Kusano, Ebina-shi (JP); Takanori Masui, Ebina-shi (JP); Makoto Takada, Ebina-shi (JP); Masato Sugii, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/264,625

(22) Filed: Nov. 1, 2005

(30) Foreign Application Priority Data
Aug. 26, 2005 (JP) 2005-245500

(51) Int. Cl. G06F 15/16

(52) U.S. Cl. 709/206

(57) ABSTRACT

Connected to a network are an electronic mail device, a directory server, and an intranet which connects devices such as a PC, a scanner, an Internet fax, and the like. The e-mail device includes a network I/F, a memory unit, an access determination unit, an entry determination unit, a certificate registration unit for registering a public key certificate in the e-mail device, and an information registration unit for accessing the directory server.

### BACKGROUND

1. Technical Field

The present invention relates to an electronic mail device, and more particularly to an electronic mail (e-mail) device which can transmit and receive encoded e-mails to and from devices such as scanners and Internet facsimiles using a public key system.

2. Related Art

In connection with recent advancements in information technology, network infrastructure services such as a directory service are now commonly employed. A directory is typically used for managing files. By correlating files with directories which serve as containers, management of a vast number of files can be facilitated. A directory service is a service in which such directories are used not only for file management, but also for network management including management of network users and network resources. The directory service can be regarded as providing a unique database optimized for performing data inquiries and searches.

Further, in recent years, a technique of encoding e-mails using a certificate including a public key of the receiver has come into wide use, and a system for managing users' mail addresses and public keys by a directory service on a network has become commonly available. As a result, there now exist many cases in which devices such as personal computers (PC), network scanners, and Internet facsimiles (fax) (hereinafter simply referred to as “devices”) are managed, along with e-mail devices, by means of a directory service.

Information items managed by a directory service are referred to as “objects,” and include user information, computer information, group information, printers, shared folders, and the like. In other words, a directory service offers a system which achieves unified management of computer-related information provided at various portions on a network and information concerning users who use this computer-related information.

An object is composed of attributes and values. A set of attributes is referred to as an “entry.” Further, entries are stored in a database in a format of a tree structure referred to as DIT (Directory Information Tree). LDAP (Lightweight Directory Access Protocol) is the standard protocol operated on TCP/IP when Accessing to a directory service, and is defined in RFC2251-RFC2256. A server which provides a directory service is referred to as a directory server or LDAP server.

Conventionally, in order to employ a directory service, an administrator must register the public key of the e-mail device in advance in the directory service. Accordingly, when the certificate of the e-mail device is updated, the certificate registered in the directory service must also be updated.

When performing transmission and reception of encoded e-mails between devices, if a directory service is not used, the devices must exchange public key certificates with one another, disadvantageously requiring extra steps. More specifically, before transmitting an encoded mail, the device must perform processing for either receiving a mail having attached thereto the certificate from the other device, or downloading the certificate of the other device from elsewhere. Furthermore, when the certificate is changed, the above processing must be performed again.

Even when a directory service is used, for smooth performance of transmission and reception of encoded e-mails, the administrator of the directory service must appropriately update device information whenever such updates are effected. If the administrator of the directory service fails to properly perform updates, transmission and reception of encoded e-mails between devices cannot be performed.

### SUMMARY

According to an aspect of the present invention, there is provided an e-mail device which performs data transmission and reception by means of encoded electronic mails to and from an image processor or a device while using public key certificates managed by a directory service. The e-mail device comprises an access determination unit which determines whether or not a directory server which offers the directory service is accessible by the e-mail device; an entry determination unit which determines, when the directory server is accessible, whether or not an entry of the e-mail device is found within the directory server; and a certificate registration unit which registers a public key certificate of the e-mail device in the directory server when the entry is found.

### BRIEF DESCRIPTION OF THE DRAWINGS

Embodiments of the present invention will be described in detail by reference to the appended drawings, wherein:

FIG. 1 is a configuration diagram showing an overall configuration of an embodiment of the present invention;

FIG. 2 is a diagram explaining a flow of processing performed by an e-mail device according to the embodiment of the present invention; and

FIG. 3 is a flowchart showing a processing flow performed by an e-mail device according to the embodiment of the present invention.

### DETAILED DESCRIPTION

Embodiments of the present invention are next described referring to the drawings.

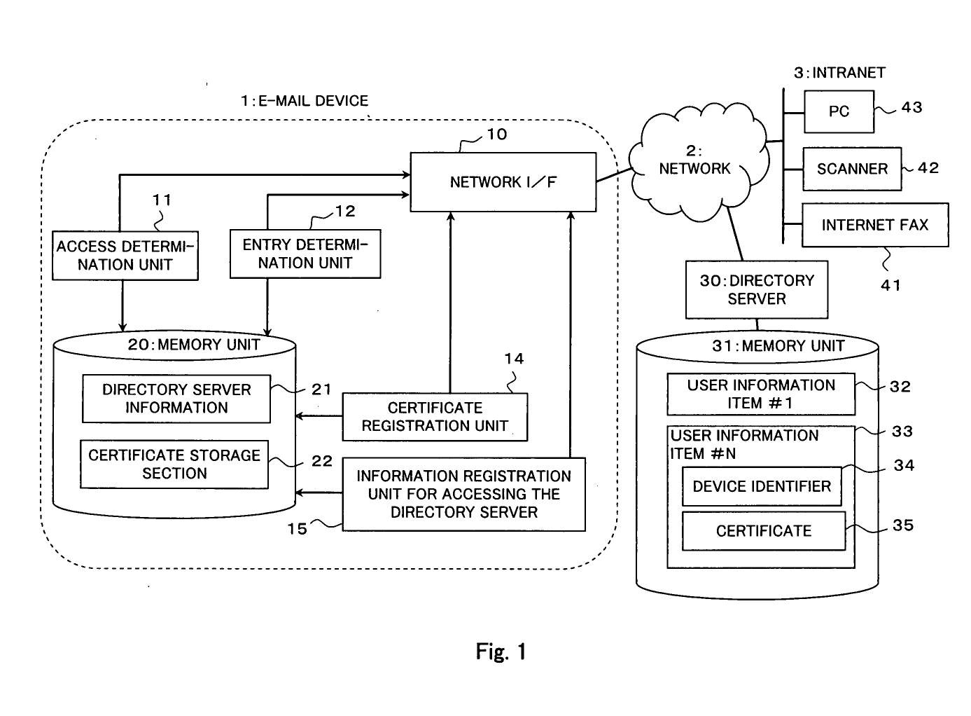

FIG. 1 is a configuration diagram showing an overall configuration of an embodiment of the present invention. Connected to a network 2 are an electronic mail device 1, a directory server 30, and an intranet 3 which connects devices such as a PC 43, a scanner 42, an Internet fax 41, and the like. The e-mail device 1 includes a network I/F (interface) 10, a memory unit 20, an access determination unit 11, an entry determination unit 12, a certificate registration unit 14 for registering a public key certificate in the e-mail device 1, and an information registration unit 15 for accessing the directory server 30. The directory server 30 includes a memory unit 31 which stores therein user information item #1 (32) through #N (33). Each user information item includes a device identifier 34 and a certificate 35.

Each of the devices such as the PC 43, the scanner 42, and the Internet fax 41 includes a memory unit (not shown). Stored in advance in the memory unit of each device are information for identifying the external directory server 30, a log-in name and a corresponding password for accessing the server, and attribute types including respective ones of a mail address and a certificate (which are information items included in information possessed by the external directory server 30). Further, access privileges to the external directory server 30 are appropriately set in the external directory server 30 with respect to each of the devices.

For each of the devices, a mail address, a domain name, a serial number, a MAC address, and the like are used to define the “object,” which is the registration information of each device.

More specifically, the object is defined by registering within each device “the attribute types of information for uniquely identifying the device” and “information which uniquely identifies the device.”

Each device generates its own certificate including a private key required for receiving an encoded mail, or alternatively, acquires such a certificate from outside. Further, each device is capable of exporting to the outside a certificate including a public key (a public key certificate) which is used by other devices and terminals for transmitting an encoded mail to the device.

At a point when the above-noted settings are partially or entirely completed, or when a certificate is changed or updated in the device, each device accesses the external directory server 30, and identifies and acquires its own registration information by searching for an object that corresponds to “information which uniquely identifies the device” from among “the attribute types of information for uniquely identifying the device.”

In the directory server 30, when no information corresponding to the device is registered, or when information concerning the mail address and the certificate of the device are not registered or do not match with corresponding information within the device, the device newly creates, adds, or updates the information within the scope of access privilege set by the directory server 30 located outside the intranet 3.

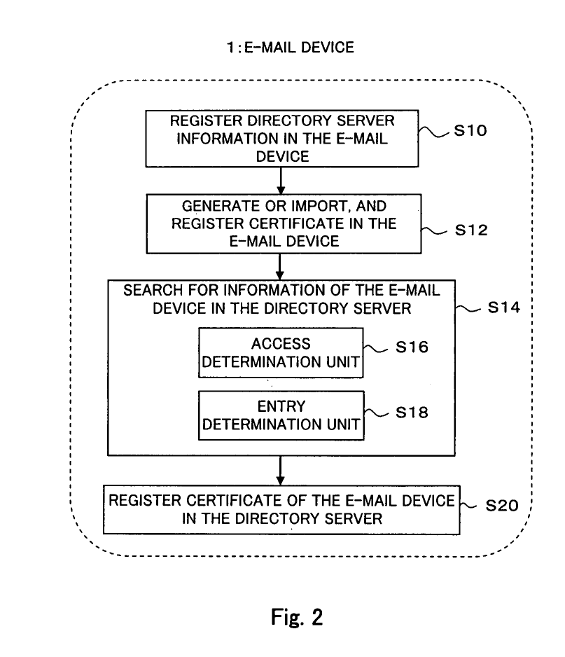

FIG. 2 is a diagram explaining a flow of processing performed by the e-mail device 1 according to the present embodiment. The outline of the flow is shown in FIG. 2. In step S10, the e-mail device 1 registers, in its memory unit 20, information concerning the directory server 30. In step S12, the e-mail device 1 creates or imports a certificate and registers the certificate in a certificate storage section 22 of the memory unit 20. In step S14, the e-mail device 1 performs a search in the directory server 30 for information concerning the device 1 itself by executing the following two steps. The first step is step S16 using the access determination unit 11, and the second step is S18 using the entry determination unit 12. Finally, the e-mail device 1 registers its own identifier and certificate in the memory unit 31 of the directory server 30.

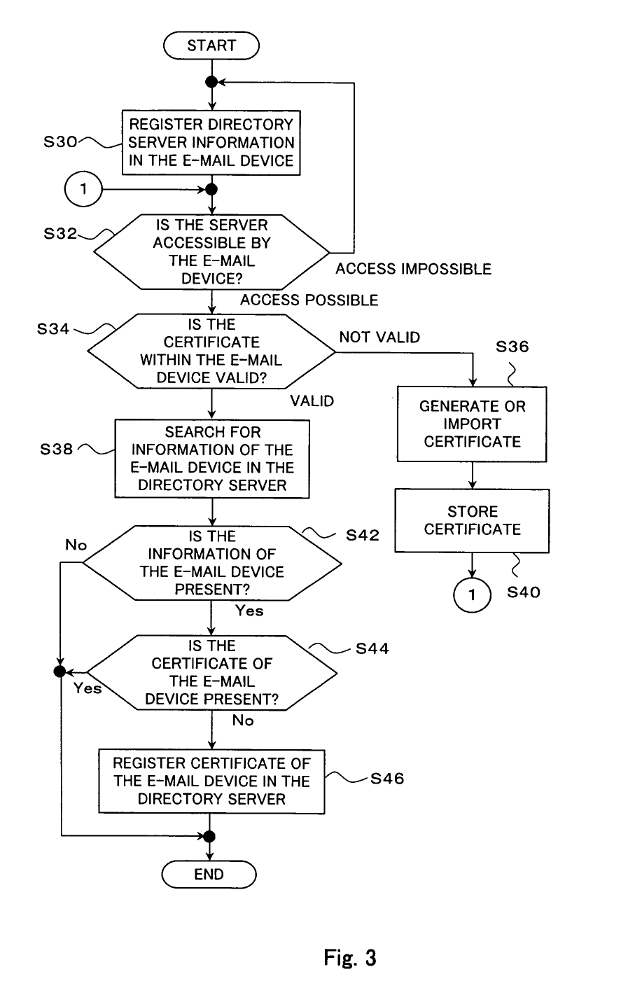

FIG. 3 is a flowchart showing processing performed by an e-mail device according to the embodiment of the present invention. The detailed processing flow is shown in FIG. 3. When the processing is started, in step S30, the e-mail device 1 registers, in its memory unit 20, information concerning the directory server 30. In step S32, the e-mail device 1 confirms whether or not the device 1 can access the server 30. When the e-mail device 1 cannot access the server 30 (despite absence of network failure), it is determined that incorrect information concerning the directory server 30 is registered in the e-mail device 1. Accordingly, processing returns to step S30 to re-register information concerning the directory server 30.

When it is confirmed that the e-mail device 1 is able to access the server 30, in step S34 the e-mail device 1 determines presence and validity of a certificate within the e-mail device 1. If the certificate is not valid, the e-mail device 1 creates (generates within the device 1) or imports from the outside a certificate in step S36, stores the obtained certificate in the certificate storage section 22 in step S40, and returns to step S32.

When in step S34 it is determined that the certificate within the e-mail device 1 is valid, the e-mail device 1 searches for its own information in the directory server 30 in step S38, and in step S42, determines presence of such information related to the e-mail device 1. When it is determined that information related to the e-mail device 1 is not present, the e-mail device 1 executes an error processing (not shown) to end the present procedure, or alternatively, if the e-mail device 1 is granted access privilege to the directory server 30, the e-mail device 1 creates information related to the device 1 itself on the directory server 30 and continues the present procedure.

When in step S42 it is determined that information related to the e-mail device 1 is present, in step S44 the e-mail device 1 determines presence of a certificate of the e-mail device 1 within the directory server 30. When the presence of the certificate is determined, the present procedure may be ended normally, or alternatively, according to the present embodiment, the e-mail device 1 determines whether the certificate is outdated. When the certificate is determined to be outdated, the e-mail device 1 registers a new certificate of the device 1 in the directory server 30. Further, when it is determined in step S44 that the certificate is not present within the directory server 30, in step S46 the e-mail device 1 registers the certificate of the device 1 in the directory server 30, and ends the present processing.

According to the present embodiment described above, an administrator of the directory service can keep updating the information stored in the directory service in synchronization with updating of corresponding information within the e-mail device 1 by simply granting in advance an appropriate access privilege to the e-mail device 1. As a result, management of the e-mail device 1 and the directory service can be performed without awareness of the status of certificate information of other parties.

The administrator of the directory server 30 can set access privileges for each device in accordance with the operation environment in order to, for example, limit the access privilege of a device to new creation and updating of the devices own information within the directory server 30. In this manner, it is possible to avoid undesirable accesses to the server 30 and appropriately maintain security of the information of the directory service.

Although the present invention has been described using specific terms, such description is for illustrative purpose only, and it is to be understood that modifications and variations may be made without departing from the spirit and scope of the appended claims. For example, the present invention may be practiced in a network other than those having an Internet fax and a scanner connected thereto. Further, the present invention may be applied to a directory service configured within an intranet.

The entire disclosure of Japanese Patent Application No. 2005-245500 filed on Aug. 26, 2005 including the specification, claims, drawings, and abstract is incorporated herein by reference.

What is claimed is:

1. An e-mail device which performs data transmission and reception by means of encoded electronic mails to and from an image processor or a device while using public key certificates managed by a directory service, the e-mail device comprising:
an access determination unit which determines whether or not a directory server which offers the directory service is accessible by the e-mail device;
an entry determination unit which determines, when the directory server is accessible, whether or not an entry of the e-mail device is found within the directory server; and
a certificate registration unit which registers a public key certificate of the e-mail device in the directory server when the entry is found.

2. An e-mail device as defined in claim 1, further comprising:
a certificate validity determination unit which acquires an expiration date of a certificate so as to determine validity of the certificate; and
a certificate update unit which causes the certificate registration unit to register a new public key certificate in the directory server when the certificate validity determination unit determines that a public key certificate registered in the directory server is older than the current certificate.

3. An e-mail device as defined in claim 1, wherein
the certificate registration unit registers a new public key certificate in the directory server when a certificate within the e-mail device is newly registered or updated.

4. An e-mail device as defined in claim 1, wherein
the certificate registration unit registers a new public key certificate in the directory server when at least one information item registered in the accessed directory server is updated within the e-mail device.

5. An e-mail device as defined in claim 1, further comprising:
a certificate validity determination unit which determines whether or not a public key certificate registered in the directory server is older than the current certificate; and
an update request notification unit which sends a notification prompting an administrator of the directory server to update the certificate of the e-mail device when the public key certificate registered in the directory server is old.

6. An e-mail device as defined in claim 1, further comprising:
a receiving unit which receives a request to upload the public key of the e-mail device from another party owning a device; wherein
the certificate registration unit registers the public key certificate in the directory server in accordance with the received request.

7. A method for controlling an e-mail device which performs data transmission and reception by means of encoded electronic mails to and from an image processor or a device, the control method comprising:
determining whether or not a directory server which offers a directory service is accessible by the e-mail device;
determining, when the directory server is accessible, whether or not an entry of the e-mail device is found within the directory server; and
registering a public key certificate of the e-mail device in the directory server when the entry is found.

8. A control method as defined in claim 7, further comprising:
acquiring an expiration date of a certificate so as to determine validity of the certificate; and
causing a registration unit to register a new public key certificate in the directory server when the certificate validity determination unit determines that a public key certificate registered in the directory server is older than the current certificate.

9. A control method as defined in claim 7, further comprising:
registering a new public key certificate in the directory server when a certificate within the e-mail device is newly registered or updated.

10. A control method as defined in claim 7, further comprising:
registering a new public key certificate in the directory server when at least one information item registered in the accessed directory server is updated within the e-mail device.

11. A control method as defined in claim 7, further comprising:
determining whether or not a public key certificate registered in the directory server is older than the current certificate; and
sending a notification prompting an administrator of the directory server to update the certificate of the e-mail device when the public key certificate registered in the directory server is old.

12. A control method as defined in claim 7, further comprising:
receiving a request to upload the public key of the e-mail device from another party owning a device; and
registering the public key certificate in the directory server in accordance with the received request.

13. A program for controlling an e-mail device which performs data transmission and reception by means of encoded electronic mails to and from an image processor or a device, the program causing a computer to execute:
determining whether or not a directory server which offers the directory service is accessible by the e-mail device;
determining, when the directory server is accessible, whether or not an entry of the e-mail device is found within the directory server; and
registering a public key certificate of the e-mail device in the directory server when the entry is found.

14. A program as defined in claim 13, causing the computer to further execute:
acquiring an expiration date of a certificate so as to determine validity of the certificate; and
causing a registration unit to register a new public key certificate in the directory server when the certificate validity determination unit determines that a public key certificate registered in the directory server is older than the current certificate.

15. A program as defined in claim 13, causing the computer to further execute:
registering a new public key certificate in the directory server when a certificate within the e-mail device is newly registered or updated.
